(19) United States
(12) Patent Application Publication
(10) Pub. No.: US 2016/0075276 A1
(43) Pub. Date: Mar. 17, 2016

(54) VEHICLE-INTERIOR ILLUMINATION DEVICE

(71) Applicant: YAZAKI CORPORATION, Tokyo (JP)

(72) Inventors: Terumitsu SUGIMOTO, Shizuoka (JP); Tomonori OHASHI, Shizuoka (JP); Takashi WAKASUGI, Shizuoka (JP); Yoko OGAWA, Shizuoka (JP); Gosei SATO, Shizuoka (JP)

(21) Appl. No.: 14/849,908

(22) Filed: Sep. 10, 2015

(30) Foreign Application Priority Data
Sep. 12, 2014 (JP) 2014-186034

(51) Int. Cl. B60Q 3/02

(52) U.S. Cl. CPC B60Q 3/0296; B60Q 3/0203; B60Q 3/0286

(57) ABSTRACT

A vehicle-interior illumination device for illuminating a cabin of a vehicle (1) includes a plurality of seat lamps (21-31) individually illuminating seats (3-11) in the cabin and operating units (21a-31a) for each seat arranged in the cabin so as to respectively correspond with the seat lamps (21-31). Each of the operating units (21a-31a) for each seat is provided with an area that is touchable by an occupant on corresponding seat and with another area that is touchable by occupants on adjacent seats, so as to turn on or off the corresponding seat lamp by touching the areas.

### CROSS REFERENCE TO RELATED APPLICATIONS

This application claims the priority of Japanese Patent Application No. 2014-186034, filed on Sep. 12, 2014, the entire content of which are incorporated herein by reference.

### BACKGROUND

1. Technical Field

The present invention relates to a vehicle-interior illumination device for illuminating a cabin of a vehicle.

2. Related Art

As a vehicle-interior illumination device for illuminating a cabin of a vehicle, reading lamps may be arranged in the cabin. A plurality of reading lamps is arranged, corresponding to individual seats, where each reading lamp individually illuminates a corresponding seat. Each of the reading lamps is turned on or off by operating an individual switch (refer to JP 2014-73762 A).

In addition, a switch for a reading lamp is arranged in a field of view of an occupant on a seat, such as on an upper portion of a door or a window on a side of the seat (e.g., a side of a roof liner), so that the occupant on the seat can operate the switch of the reading lamp for use.

### SUMMARY

Although various types of switches are available for reading lamps, such as push button switches and slider switches, they may tend to have a rather smaller operating unit, resulting in difficulty using such an operating unit in a moving vehicle. Also, when a position of a seat is slid, the seat goes away from a switch, possibly resulting in difficulty using the switch. Moreover, when an occupant on another seat tries to turn off a reading lamp that remain lit, or when a parent tries to turn on or off a reading lamp of a seat where his or her child is seated on, the occupant or the parent has to move to the seat that is subject to illumination by the reading lamp to operate the switch.

The present invention has been made in light of the above described circumstances, and an object of the present invention is to provide a vehicle-interior illumination device having improved operability when turning on or off illuminations, including reading lamps, individually illuminating seats in a cabin.

A vehicle-interior illumination device according to one aspect of the present invention is a vehicle-interior illumination device for illuminating a cabin of a vehicle. The vehicle-interior illumination device includes a plurality of seat lamps individually illuminating seats in the cabin and a plurality of operating units for each seat arranged in the cabin so as to respectively correspond with the seat lamps. Each of the plurality of operating units for each seat is provided with an area that is touchable by an occupant on corresponding seat and with another area that is touchable by occupants on adjacent seats, so as to turn on or off the corresponding seat lamp by touching the areas.

According to an aspect of the present invention, an operating unit for each seat is touch-operable by an occupant on a seat that is subject to illumination by a corresponding seat lamp, as well as by other occupants on adjacent seats. Therefore, the seat lamp can be turned on or off from not only the seat that is subject to illumination by the seat lamp, but also adjacent seats for improved operability of turning on or off seat lamps.

Each of the operating units for each seat may be provided with the area that is touchable by the occupant on corresponding seat and with areas that are touchable by occupants on front and rear adjacent seats.

In this vehicle-interior illumination device, each operating units for each seat is touch-operable from a seat that is subject to illumination by a corresponding seat lamp, as well as from front and rear adjacent seats. Therefore, even when a position of a seat is moved forward or rearward, an operating unit for each seat corresponding to the seat can be touch-operated by occupants.

In addition, configuring an operating unit for each seat that can be touched by occupants on front and rear adjacent seats requires the operating unit for each seat to extend in a front-rear direction. Accordingly, operating units for each seat can be touch-operated by occupants in various postures, even though such a posture, which is taken when touch-operating an operating unit for each seat, vary due to some reasons including variation in passenger's generations including, for example, elderly passengers who might be comparatively difficult to raise their arms high.

Moreover, such operating unit for each seat may be arranged on a ceiling of the cabin.

In this vehicle-interior illumination device, as the operating unit for each seat is arranged on the ceiling of the cabin, the operating unit for each seat can be prevented from being touch-operated mistakenly by passengers, other than when turning on or off a seat lamp.

With a vehicle-interior illumination device according to an aspect of the present invention, seat lamps for individually illuminating seats in a cabin can be turned on or off in an improved manner.

### BRIEF DESCRIPTION OF DRAWINGS

FIG. 1 shows one embodiment according to the present invention, and is an explanatory diagram showing an arrangement of a vehicle-interior illumination device;

FIG. 2 is a block diagram showing a schematic configuration of a control system of map lamps and reading lights shown in FIG. 1;

FIG. 3 is an explanatory diagram showing an arrangement of map lamp switches and reading light switches in the cabin;

FIG. 4 shows a variation of one embodiment according to the present invention, and is an explanatory diagram showing an arrangement of a vehicle-interior illumination device;

FIG. 5 shows another variation of one embodiment according to the present invention, and is an explanatory diagram showing an arrangement of a vehicle-interior illumination device; and

FIG. 6 shows another embodiment according to the present invention, and is an explanatory diagram showing an arrangement of a vehicle-interior illumination device.

### DETAILED DESCRIPTION

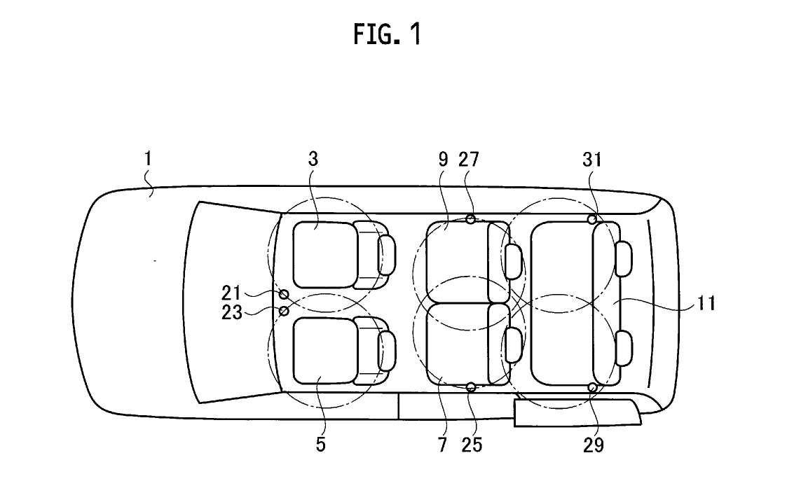

Hereinafter, embodiments of a vehicle-interior illumination device according to the present invention will be explained with reference to drawings. FIG. 1 is an explanatory diagram showing an arrangement of the vehicle-interior illumination device according to one embodiment of the present invention.

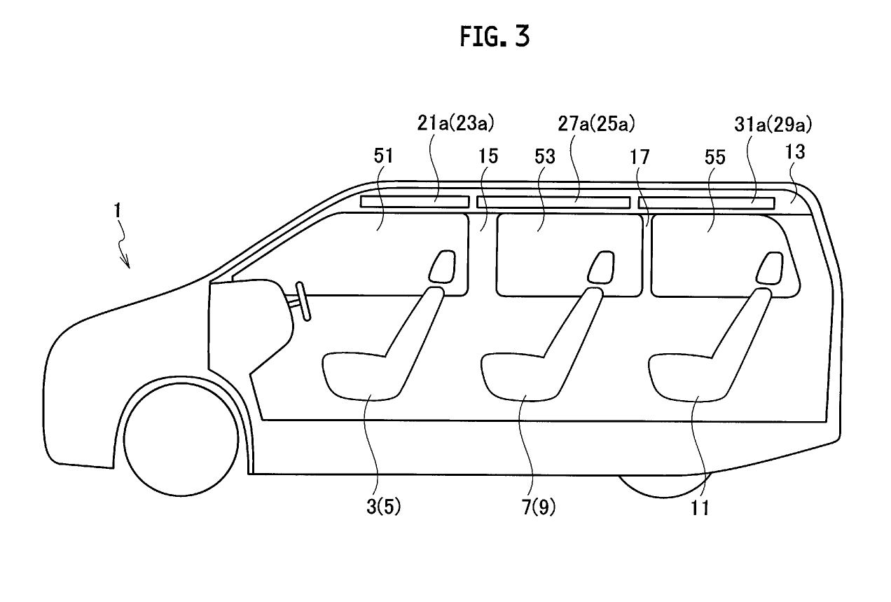

As shown in FIG. 1, in a vehicle 1, map lamps 21, 23 illuminating a driver's seat 3 and a passenger's seat 5 are provided at a front center of a vehicle-interior roof liner 13 (corresponding to “a ceiling of the cabin”: refer to FIG. 3). In addition, also at both right and left sides of the roof liner 13, reading lights 25 to 31 illuminating second-row and third-row seats 7, 9, and 11 (corresponding to “a plurality of seat lamps”) are provided, respectively.

In addition, in FIG. 1, ranges illuminated by the map lamps 21 and 23 and the reading lamps 25 to 31 are indicated with dashed-line circles. A seat 11 in a third row is a three-seater seat, where an occupant on a center of the seat 11 is illuminated by both of the reading lamps 29 and 31 arranged on left and right. In this embodiment, the driver seat 3, the front passenger seat 5, and the seats 7, 9, and 11 correspond to the seats described in the claims, configuring a vehicle-interior illumination device according to an embodiment of the present invention, including the map lamps 21 and 23 and the reading lamps 25 to 31.

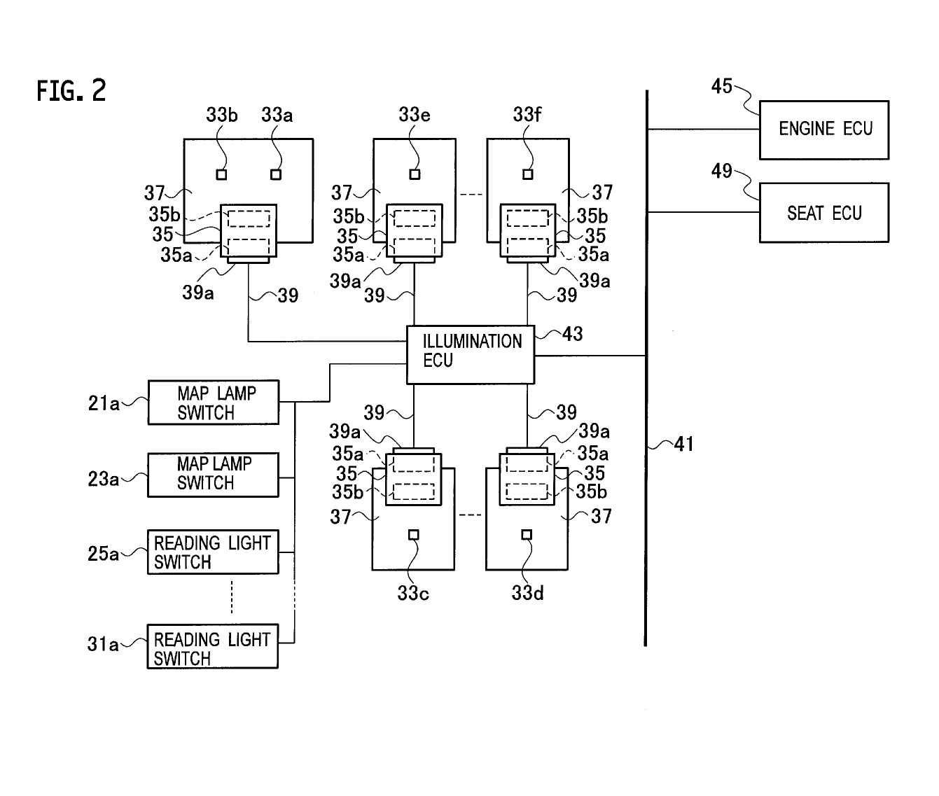

Next, a schematic configuration of the control system of the map lamps 21 and 23 and the reading lights 25 to 31 will be explained with reference to a block diagram of FIG. 2. In the present embodiment, the respective map lamps 21 and 23 have light sources 33a and 33b, respectively. The respective reading lights 25 to 31 also have light source 33c to 33f, respectively. The respective light sources 33a to 33f are constituted of three LED chips of RGB in the present embodiment, and are constituted so as to be able to emit arbitrary color light by adjusting each luminance thereof.

The light sources 33a to 33f of the respective map lamps 21 and 23 and the respective reading light 25 to 31 are each mounted on a circuit board 37 together with a connector 35 with a built-in controller. The connector 35 with the built-in controller has: a female connector part 35a to which a male connector 39a of a multiplex communication line 39 can be connected; and a controller 35b including, for example, one-chip microcomputer.

The light sources 33a to 33f are each connected to the controller 35b via a conductive pattern, which is not shown, of the circuit board 37. Additionally, the controller 35b controls lighting on or off of the light sources 33a and 33b of the respective map lamps 21 and 23, and the light source 33c to 33f of the respective reading lights 25 to 32 on the basis of a control signal input from an illumination ECU (Electronic Control Unit) 43 via the multiplex communication line 39.

The circuit boards 37 described above are arranged in gaps between a roof liner 13 of the vehicle 1 and a body of the vehicle 1 (back of the roof liner 13) shown in the explanatory drawing of FIG. 3. The roof liner 13 is an interior material used in the cabin, covering from upper ends of side glasses 51 to 55 to a ceiling of the vehicle 1. In this roof liner 13, lamp windows (not shown) are arranged for transmitting light from light sources 33a to 33f of the map lamps 21 and 23 and the reading lamps 25 to 31.

The multiplex communication line 39 from illumination ECU 43 connected to the connector 35 with the built-in controller on the circuit board 37, as shown in FIG. 2, is routed inside the pillars 15 and 17 of the vehicle 1 as shown in FIG. 3. Since a wiring in the pillars 15, 17 is the multiplex communication line 39, the wiring number can be decreased compared with a case of laying individual wirings respectively continuous to the respective light source 33a to 33f in the pillars 15 and 17, and limited spaces in the pillars 15 and 17 through which many other wirings are also passed can be effectively utilized.

As shown in FIG. 2, an engine ECU 45, which controls a drive system and a body system of the vehicle 1, a seat ECU 49, etc. are coupled to the lighting ECU 43 via an on-board LAN 41. Also, map lamp switches 21a and 23a for turning on or off the map lamps 21 and 23, as well as reading lamp switches 25a to 31a for turning on or off the reading lamps 25 to 31 are coupled to the lighting ECU 43 via an interface (not shown).

The map lamp switches 21a and 23a and the reading lamp switches 25a to 31a correspond to the operating units for each seat described in the claims, and are configured by, for example, electrostatic capacity type touch panel switches. Each time the map lamp switches 21a and 23a and the reading lamp switches 25a to 31a are touch-operated, the lighting ECU 43 repeats turning on and off of the corresponding map lamps 21 and 23 and the reading lamps 25 to 31.

As shown in FIG. 3, the touch panels of the map lamp switches 21a and 23a and the reading lamp switches 25a to 31a are arranged on the roof liner 13 that runs on upper edges of the side glasses 51 to 55. The map lamp switches 21a and 23a and the reading lamp switches 25a to 31a are arranged in a long belt-like shape running longitudinally to a front-rear direction of the vehicle 1.

The map lamp switches 21a and 23a are formed in a front-rear length so that the map lamp switches 21a and 23a are touch-operated by occupants on the driver seat 3 and the front passenger seat 5 in an entire moving range in a front-rear direction of the driver seat 3 and the front passenger seat 5. Also, portions near rear edges of the map lamp switches 21a and 23a are arranged in positions where occupants on the seats 7 and 9 in a second row can touch-operate the switches in an entire moving range in a front-rear direction of the seats 7 and 9.

The reading lamp switches 25a and 27a are formed in a front-rear length so that the reading lamp switches 25a and 27a are touch-operated by occupants on the seats 7 and 9 in the second row in an entire moving range in a front-rear direction of the seats 7 and 9. Also, portions near front edges of the reading lamp switches 25a and 27a are arranged in positions where occupants on the driver seat 3 and the front passenger seat 5 can touch-operate the switches in an entire moving range in a front-rear direction of the driver seat 3 and the front passenger seat 5. Moreover, portions near rear edges of the reading lamp switches 25a and 27a are arranged in positions where occupants on the seat 11 can touch-operate the switches in an entire moving range in a front-rear direction of the seat 11.

The reading lamp switches 29a and 31 a are formed in a front-rear length so that the reading lamp switches 29a and 31 a are touch-operated by occupants on the seat 11 in the third row in an entire moving range in a front-rear direction of the seat 11. Also, portions near front edges of the reading lamp switches 29a and 31a are arranged in positions where occupants on the seats 7 and 9 can touch-operate the switches in an entire moving range in a front-rear direction of the seats 7 and 9.

The illumination ECU 43 controls lighting on or off of the map lamps 21 and 23 and the reading lights 25 to 31. For that reason, the illumination ECU 43 has a CPU, a RAM, a ROM, a hard disk (none of them are shown), and the like. Additionally, the CPU performs control of lighting on or off of the light sources 33a to 33f of the map lamps 21 and 23 and the reading lights 25 to 31 by using the RAM as a work area while referring to a table stored in the hard disk in accordance with a program stored in the ROM.

As described above, in this embodiment, the map lamp switches 21 a and 23 a for turning on or off the map lamps 21 and 23 that illuminate the driver seat 3 and the front passenger seat 5 are arranged so as to be touch-operated by not only occupants on the driver seat 3 and the front passenger seat 5, but also occupants on the seats 7 and 9 in the second row at rear adjacent to the driver seat 3 and the front passenger seat 5.

Similarly, in this embodiment, the reading lamp switches 25a and 27a for turning on or off the reading lamps 25 and 27 that illuminate the seats 7 and 9 in the second row are arranged so as to be touch-operated by not only occupants on the seats 7 and 9 in the second row, but also occupants on the driver seat 3 and the front passenger seat 5 at front adjacent to the seats 7 and 9 and occupants on the seat 11 in the third row at rear adjacent to the seats 7 and 9.

Also, in this embodiment, the reading lamp switches 29a and 31 a for turning on or off the reading lamps 29 and 31 that illuminate the seat 11 in the third row are arranged so as to be touch-operated by not only occupants on the seat 11 in the third row, but also occupants on the seats 7 and 9 in the second row at front adjacent to the seat 11.

Therefore, the map lamps 21 and 23 and the reading lamps 25 to 31 can be turned on or off from not only the corresponding driver seat 3 and the front passenger seat 5, the seats 7, 9 and 11 in the second and third rows, which are subject of illumination by the map lamps 21 and 23 and the reading lamps 25 to 31, but also front and rear adjacent seats for improved operability when turning on or off of the map lamps 21 and 23 and the reading lamps 25 to 31.

Also, in this embodiment, the map lamp switches 21a and 23a and the reading lamp switches 25a to 31a are arranged in a long belt-like shape in a front-rear direction so that the map lamp switches 21a and 23a and the reading lamp switches 25a to 31a can securely be touch-operated by occupants even though the driver seat 3 and the front passenger seat 5, the seats 7, 9 and 11 in the second and the third rows are moved forward or rearward.

Further, arranging the map lamp switches 21a and 23a and the reading lamp switches 25a to 31a in a long belt-like shape in a front-rear direction allows occupants to touch-operate the operating units for each seat in various postures, even though such a posture, which is taken when touch-operating an operating unit for each seat, vary due to some reasons including variation in passenger's generations including, for example, elderly passengers who might be comparatively difficult to raise their arms high.

Incidentally, the map lamp switches 21a and 23a and the reading lamp switches 25a to 31a may be a mechanical type where pressing a switch by an occupant causes the switch to displace against a spring force to open or close a contact (not shown), alternative to an electrostatic capacity type touch panel switches.

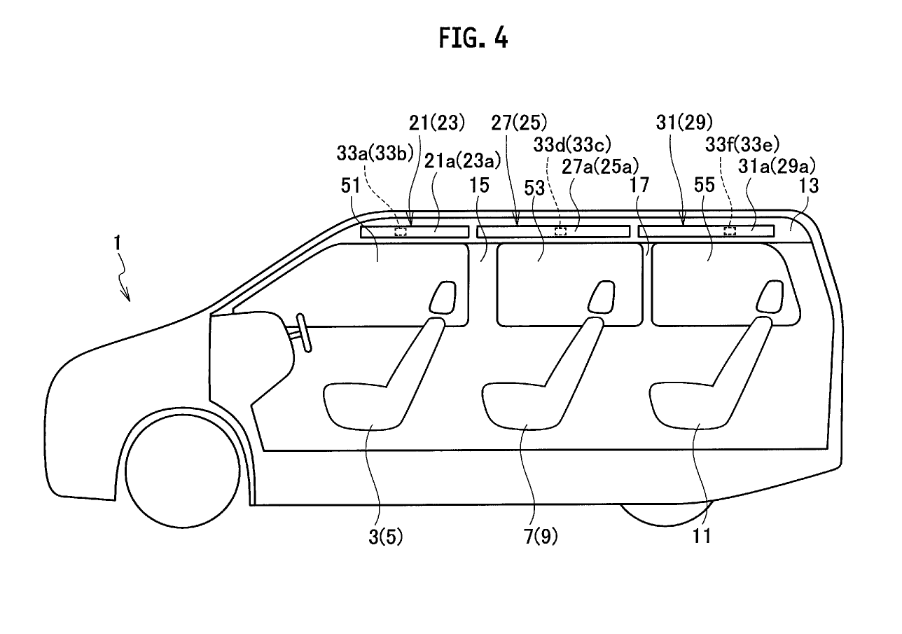

Also, as a variation shown in the explanatory drawing of FIG. 4, the map lamp switches 21a and 23a and the reading lamp switches 25a to 31a may be configured in a transparent hollow box to internally accommodate light sources 33a to 33f of the map lamps 21 and 23 and the reading lamps 25 to 31. In this case, portions of the map lamp switches 21a and 23a and the reading lamp switches 25a to 31a, which are exposed into the cabin without being covered by the roof liner 13, transmit light from the light sources 33a to 33f into the cabin, alternative to the lamp windows (not shown) of the roof liner 13.

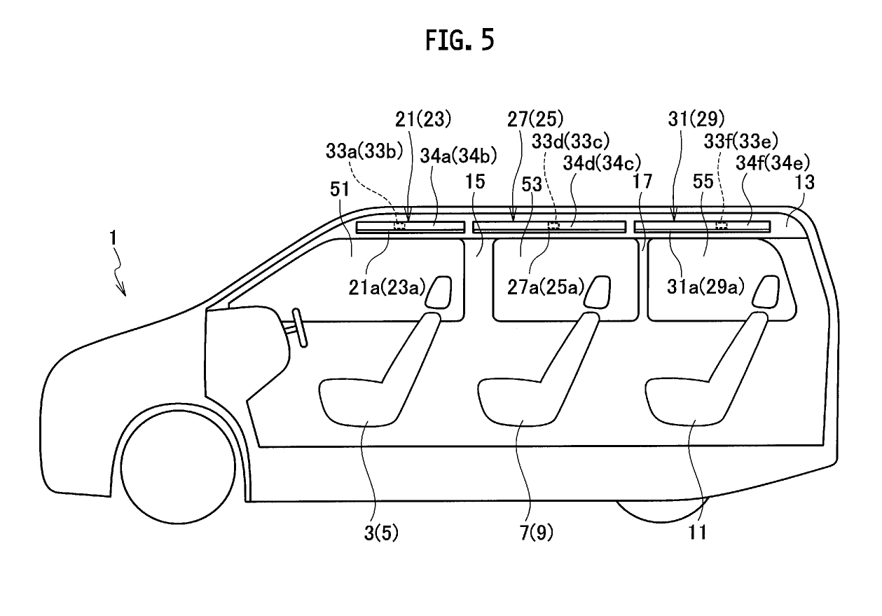

Moreover, as another variation shown in the explanatory drawing of FIG. 5, for example, lamp windows 34a to 34f of the roof liner 13, which correspond to the light sources 33a to 33f, may be arranged along the map lamp switches 21a and 23a and the reading lamp switches 25a to 31a so as to be exposed into the cabin.

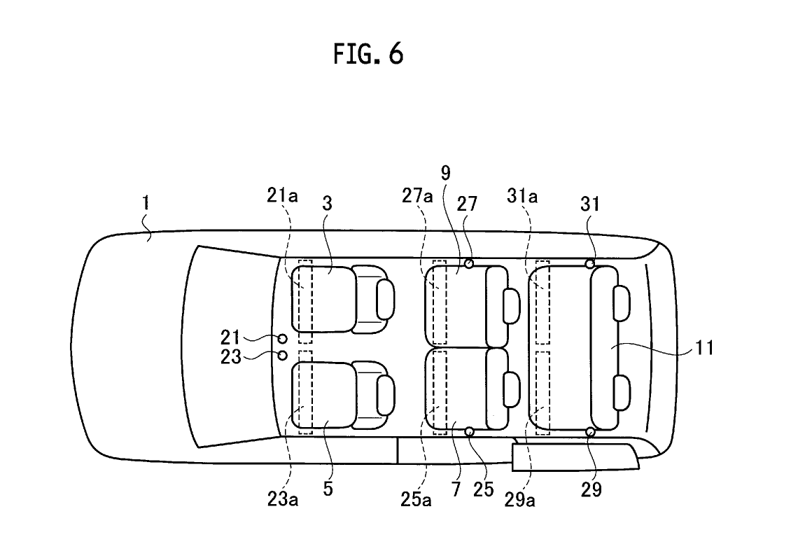

In addition, as shown in dashed line in the explanatory drawing of FIG. 6, illustrating an arrangement of a vehicle-interior illumination device according to another embodiment of the present invention, the map lamp switches 21a and 23a and the reading lamp switches 25a to 31a may be arranged in a long horizontal belt-like shape. In this case, the touch panels of the map lamp switches 21a and 23a and the reading lamp switches 25a to 31a are arranged at ceiling portions of the roof liner 13.

In this case, the map lamp switches 21a and 23a are arranged so as to be touch-operated by both of occupants on the driver seat 3 and the front passenger seat 5. Also, the reading lamp switches 25a and 27a are arranged so as to be touch-operated by both of occupants on the seats 7 and 9 in the second row. Moreover, the reading lamp switch 29a is arranged so as to be touch-operated by not only occupants on a center and a left side (reading lamp 29 side) of the seat 11 in the third row, but also an occupant on a right side (reading lamp 31 side) of the seat 11, whereas the reading lamp switch 31a is arranged so as to be touch-operated by not only occupants on the center and the right side (reading lamp 31 side) of the seat 11 in the third row, but also an occupant on the left side (reading lamp 29 side) of the seat 11.

When configured like this, the map lamps 21 and 23 and the reading lamps 25 to 31 can be turned on or off by not only occupants on the driver seat 3 and the front passenger seat 5, the seats 7, 9 and 11 in the second and the third rows, which are subject of illumination by the map lamps 21 and 23 and the reading lamps 25 to 31, but also occupants on seats at left and right adjacent to the seats that are subject to illumination by the map lamps 21 and 23 and the reading lamps 25 to 31. In this case, the map lamps 21 and 23 and the reading lamps 25 to 31 can also be turned on or off in an improved manner.

In any of the embodiments, the touch panels of the map lamp switches 21a and 23a and the reading lamp switches 25a to 31a may be arranged on, for example, door trims and side trims arranged on sides of the cabin. However, it is advantageous that the map lamp switches 21a and 23a and the reading lamp switches 25a to 31a are arranged on the roof liner 13 to lower possibility of mistakenly touch-operating the switches other than when touch-operating the switches.

In addition, in the embodiment shown in FIG. 6, the variations shown in FIGS. 4 and 5 can also be configured.

Also, as shown in the embodiments and the variations described above, it is optional whether multiplex communication lines 39 that couple the lighting ECU 43 and controller-equipped connectors 35 on the circuit boards 37 for the reading lamps 25 to 31 are routed in pillars 15 and 17 of the vehicle 1. Moreover, it is optional whether the controller-equipped connectors 35 are used for coupling the lighting ECU 43 and the circuit boards 37 for the reading lamps 25 to 31.

What is claimed is:

1. A vehicle-interior illumination device for illuminating a cabin of a vehicle, comprising:
a plurality of seat lamps individually illuminating seats in the cabin; and
a plurality of operating units for each seat arranged in the cabin so as to respectively correspond with the plurality of seat lamps, wherein
each of the plurality of operating units for each seat is provided with an area that is touchable by an occupant on corresponding seat and with another area that is touchable by occupants on adjacent seats, so as to turn on or off the corresponding seat lamp by touching the areas.

2. The vehicle-interior illumination device according to claim 1, wherein each of the operating units for each seat is provided with the area that is touchable by the occupant on corresponding seat and with areas that are touchable by occupants on front and rear adjacent seats.

3. The vehicle-interior illumination device according to claim 1, wherein the operating unit for each seat are arranged on a ceiling of the cabin.
